(19) United States
(12) Patent Application Publication
(10) Pub. No.: US 2011/0073078 A1
(43) Pub. Date: Mar. 31, 2011

(54) HIGH-PRESSURE FUEL PUMP

(76) Inventors: Werner Vallon, Weil Der Stadt (DE); Gerhard Meier, Schorndorf (DE); Andreas Dutt, Stuttgart (DE); Frank Maurer, Esslingen (DE); Jochen Aleker, Stuttgart (DE)

(21) Appl. No.: 12/994,012

(22) PCT Filed: Mar. 20, 2009
(86) PCT No.: PCT/EP2009/053304

§ 371 Date: Nov. 22, 2010

(30) Foreign Application Priority Data
May 20, 2008 (DE) 102008001871.6

(51) Int. Cl. F02M 59/10; F02M 59/44

(52) U.S. Cl. 123/495

(57) ABSTRACT

The invention relates to a high-pressure fuel pump for a fuel injection system of an internal combustion engine, having a pump housing and with at least one pump element of a piston which is driven by a cam which interacts with a roller. The free ends of the roller are bounded by two side run-on surfaces which come into contact with mating surfaces during the operation of the high-pressure fuel pump. In order to provide a high-pressure fuel pump which can be produced cost-effectively and has a long service life, the side run-on surfaces are designed as circular ring disc surfaces and, in a central internal region, are released from contact with the mating surfaces.

The invention relates to a high-pressure fuel pump for a fuel injection system of an internal combustion engine, having a pump housing and having at least one pump element that includes a piston which is driven by a cam that cooperates with a roller which is defined on its ends by two lateral stop faces that in operation of the high-pressure fuel pump come into contact with opposite surfaces.

The opposite surfaces may be provided on a tappet body, for example, and they limit a motion of the roller in the axial direction.

### DISCLOSURE OF THE INVENTION

It is the object of the invention to create a high-pressure fuel pump as defined by the preamble to claim 1 which can be produced economically and has a long service life.

In a high-pressure fuel pump for a fuel injection system of an internal combustion engine, having a pump housing and having at least one pump element that includes a piston which is driven by a cam that cooperates with a roller which is defined on its ends by two lateral stop faces that in operation of the high-pressure fuel pump come into contact with opposite surfaces, this object is attained in that the lateral stop faces are embodied as circular-annular disk faces and are released in a central internal region from contact with the opposite surfaces.

A preferred exemplary embodiment of the high-pressure fuel pump is characterized in that the circular-annular disk faces are released in a coaxial outer region from contact with the opposite surfaces. As a result of the intentional releases, wear from friction caused in operation of the high-pressure fuel pump by a side run-up of the roller on the associated opposite surfaces can be reduced markedly. A face which is defined by two concentric or coaxial circles is called a circular-annular disk face. The circular-annular face can be embodied as either flat or curved.

A further preferred exemplary embodiment of the high-pressure fuel pump is characterized in that, viewed in longitudinal section through the roller, the circular-annular disk faces are each curved convexly. The radius of curvature in conventional rollers is also called the cap radius. In the roller of the invention, the conventional cap shape is varied as a result of the releases. The convexly curved circular-annular disk faces have the shape of spherical zones. The part of a spherical layer, belonging to the spherical surface, that is created when a sphere is intersected by two parallel planes is called a spherical zone.

A further preferred exemplary embodiment of the high-pressure fuel pump is characterized in that the central internal regions each include a flattened face, which is disposed perpendicular to the longitudinal axis of the roller. The flattened faces essentially have the shape of circular disks.

A further preferred exemplary embodiment of the high-pressure fuel pump is characterized in that the central internal regions each include an indentation. The indentations reliably prevent the central internal regions from coming into contact with the associated opposite surfaces.

A further preferred exemplary embodiment of the high-pressure fuel pump is characterized in that the circular-annular disk faces are raised relative to the associated coaxial outer regions. The raising or elevation reliably prevents the coaxial outer regions from coming into contact with the associated opposite surfaces.

A further preferred exemplary embodiment of the high-pressure fuel pump is characterized in that viewed in longitudinal section through the roller, the coaxial outer regions taper frustoconically. The cone angle is preferably selected such that the coaxial outer regions drop off more steeply toward the outside than the circular-annular disk faces do.

Further preferred exemplary embodiments of the high-pressure fuel pump are characterized in that the transitions between the central internal regions and the associated circular-annular disk faces, between the circular-annular disk faces and the associated coaxial outer regions, and between the coaxial outer regions and a cylindrical body of the roller are rounded. The rounded areas create gentle transitions.

Further advantages, characteristics and details of the invention will become apparent from the ensuing description, in which various exemplary embodiments are described in detail in conjunction with the drawings.

### BRIEF DESCRIPTION OF THE DRAWINGS

In the drawings:

FIG. 1 shows a detail of a high-pressure fuel pump in an exemplary embodiment in longitudinal section through a pump element;

FIG. 2 shows an enlarged detail II from FIG. 1 including a roller;

FIG. 3 shows the roller of FIG. 2 by itself in plan view;

FIG. 4 shows an enlarged detail injection valve from FIG. 3 in longitudinal section in a first exemplary embodiment; and

FIG. 5 shows the same detail as in FIG. 4, in a second exemplary embodiment.

### DESCRIPTION OF THE EXEMPLARY EMBODIMENTS

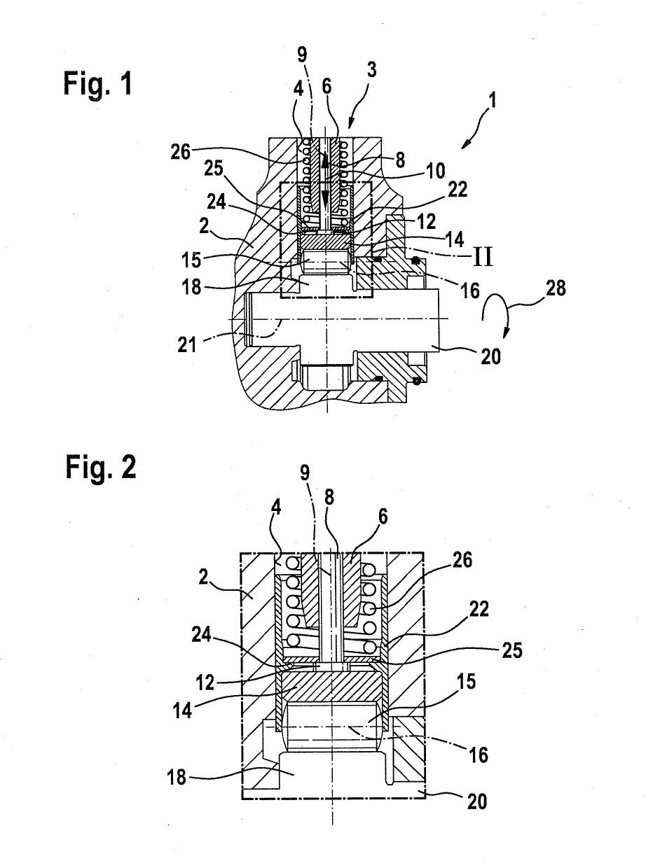

In FIGS. 1 and 2, a detail of a high-pressure fuel pump 1 with a pump housing 2 is shown in longitudinal section through a pump element 3. The high-pressure fuel pump 1 is part of a fuel injection system of a motor vehicle and serves to subject fuel, which is pumped out of a fuel tank to the high-pressure fuel pump 1, preferably with the aid of a prefeed pump, to high pressure. The fuel subjected to high pressure is then delivered to a central high-pressure fuel reservoir, also called a common rail. Fuel injection valves, which are also called injectors, are connected to the central high-pressure fuel reservoir, and by way of them, the fuel subjected to high pressure is injected into combustion chambers of an internal combustion engine.

Each pump element 3 includes an element bore 4, into which an element body 6 that originates from a cylinder head (not shown) protrudes. In the element body 6, a high-pressure piston 8 is guided movably back and forth. The high-pressure piston 8 essentially has the shape of a straight circular cylinder with a longitudinal axis 9. A double arrow 11 indicates that the high-pressure piston 8 is guided movably back and forth along the longitudinal axis 9 in the element body 6.

One end of the high-pressure piston 8 defines a pressure chamber in the cylinder head. Via a suction valve, the pressure chamber is in communication with the prefeed pump. The pressure chamber is also in communication with the central high-pressure fuel reservoir via a pressure valve. When the piston 8 moves out of the pressure chamber, fuel is aspirated into the pressure chamber. When the piston 8 moves into the pressure chamber, the fuel located in the pressure chamber is then subjected to high pressure.

On its end remote from the pressure chamber, the piston 8 has a piston base 12, which essentially has the shape of a circular disk and is connected in one piece to the piston 8. The face end, remote from the piston 8, of the piston base 12 rests on a roller shoe 14, in which a roller 15 is guided rotatably about its longitudinal axis 16. The longitudinal axis 16 of the roller 15 extends transversely to the longitudinal axis 9 of the piston 8. The roller 15 cooperates with a cam 18 of a drive shaft 20, by which shaft the piston 8 is driven. The drive shaft 20 is rotatable about an axis of rotation 21.

A tappet 22 is received in the element bore 4, movably back and forth in the direction of the longitudinal axis 9 of the piston 8. The tappet 22 essentially has the shape of a hollow circular cylinder, and radially inward it has a land 24 with which the tappet 22 is braced on the roller shoe 14. A spring plate 25, which has a central through hole through which the piston 8 extends, rests on the upper side, remote from the roller shoe 14, of the land 24. The base 12 of the piston 8 is disposed axially between the spring plate 25 and the roller shoe 18.

A restoring spring 26 for the piston 8 is fastened between the spring plate 25 and the cylinder head. The prestressing force of the restoring spring 26 keeps the piston base 12 in contact with the roller shoe 14, and keeps the roller shoe 14 in contact with the roller 15, or in other words keeps the roller 15 in contact with the cam 18 of the drive shaft 20. An arrow 28 indicates that the drive shaft 20, with the cam 18, rotates about the axis of rotation 21 in operation of the high-pressure fuel pump 1.

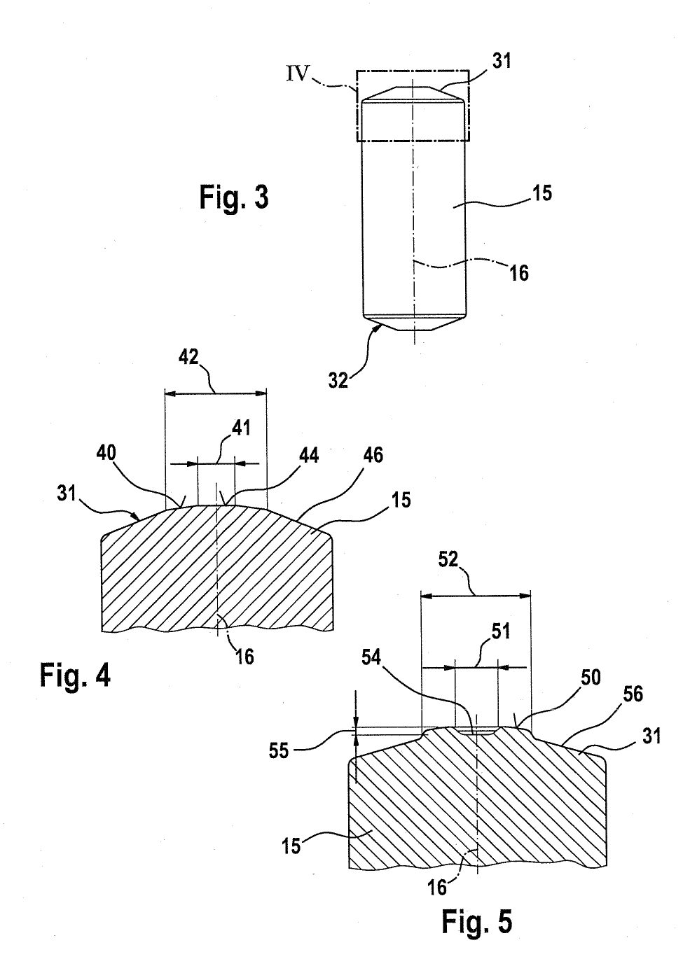

In FIG. 3, the roller 15 is shown by itself in plan view. The roller 15 essentially has the shape of a straight circular cylinder with caplike protuberances on its ends 31, 32. In the high-pressure fuel pump, the roller 15 serves as a transmission member, for converting a rotary motion of the drive shaft, in particular a camshaft, into an oscillating motion.

In operation of the high-pressure fuel pump, forces in the radial and axial directions that can affect the function of the roller 15 occur at the roller 15. To make it possible to control or intercept these forces, the roller is guided in the radial and axial directions.

In the exemplary embodiment shown in FIGS. 1 and 2, the roller 15 is guided in the radial direction in the roller shoe 14. During the rolling process, the roller shoe keeps the roller 15 in position on the opposite running face of the drive shaft and absorbs the radial motions. Axial forces are transmitted to the tappet 22 via the caps embodied on the ends 31, 32 of the roller 15.

As a result of the lateral limitation of the axial motion of the roller 15, a stop state occurs, in which the roller 15 stops at the tappet 22 that is upright relative to it. In this run-up process, at one or more contact points, friction wear occurs, which can lead to failure of the components. In an essential aspect of the invention, the ends 31, 32 of the roller 15 are optimized geometrically, to reduce wear and lengthen the service life of the components.

By means of a geometrically adapted cap geometry of the ends 31, 32, the contact region between the roller 15 and the tappet 22 is optimized in terms of the friction wear that occurs in operation, this being done by releasing the center and the peripheral region of the cap at the ends 31, 32. It is thereby attained that the center of the caps, at the ends 31, 32, where as a rule the greatest wear occurs, no longer intervenes in load-bearing fashion, and the incident frictional forces are distributed over a larger region that is better capable of absorbing them. As a result, the lateral stop behavior is improved markedly.

In FIG. 4, a detail injection valve of FIG. 3 is shown on a larger scale, in longitudinal section. In an essential aspect of the invention, the lateral stop face of the roller 15 is embodied as a circular-annular disk face 40. The circular-annular disk face 40 has the shape of a spherical zone and is convexly curved. The circular-annular disk face 40 can also have the shape of a frustoconical portion. The circular-annular disk face 40 extends about the longitudinal axis 16 of the roller 15.

The circular-annular disk face 40 has an inner diameter 41 radially inward and an outer diameter 42 radially outward. The region inside the inner diameter 41 is embodied flat, as a flattened face 44. A coaxial outer region 46, which has the shape of a frustoconical portion, extends radially outside the outer diameter 42.

In an essential aspect of the invention, the roller cap is purposefully released inside the inner diameter 41 and outside the outer diameter 42, in order to limit the contact of the side stop of the roller 15 to the circular-annular disk face 40 between the inner diameter 41 and the outer diameter 42. This releasing, as seen in FIG. 4, can be achieved by means of a change in the angle at the transition between the circular-annular disk face 40 and the coaxial outer region 46 and/or by means of the flattened face 41.

In FIG. 5, the end 31 is shown with a circular-annular disk face 50, which extends between an inner diameter 51 and an outer diameter 52. The circular-annular disk face 50 is embodied essentially identically to the circular-annular disk face 40 shown in FIG. 4. In a distinction from the preceding exemplary embodiment, an indentation 54 is provided in FIG. 5, inside the inner diameter 51. The depth or height of the indentation 51 is indicated by reference numeral 55.

Furthermore, a coaxial outer region 56, which extends radially outside the outer diameter 42, is offset from the circular-annular disk face 40 in such a way that the circular-annular disk face 40 is raised or elevated relative to the coaxial outer region. The height of the elevation is also indicated by reference numeral 55. The dimensioning of the dimensions 41; 51, 42; 52 and 55 is done as a function of the peripheral operating conditions.

1-10. (canceled)

11. A high-pressure fuel pump for a fuel injection system of an internal combustion engine, the high-pressure fuel pump having a pump housing and having at least one pump element that includes a piston which is driven by a cam that cooperates with a roller which is defined on its ends by two lateral stop faces that in operation of the high-pressure fuel pump come into contact with opposite surfaces, wherein the lateral stop faces are embodied as circular-annular disk faces and are released in a central internal region from contact with the opposite surfaces.

12. The high-pressure fuel pump as defined by claim 11, wherein the circular-annular disk faces are released in coaxial outer regions from contact with the opposite surfaces.

13. The high-pressure fuel pump as defined by claim 11, wherein, viewed in longitudinal section through the roller, the circular-annular disk faces are each curved convexly.

14. The high-pressure fuel pump as defined by claim 12, wherein, viewed in longitudinal section through the roller, the circular-annular disk faces are each curved convexly.

15. The high-pressure fuel pump as defined by claim 11, wherein each central internal region includes a flattened face, which is disposed perpendicular to a longitudinal axis of the roller.

16. The high-pressure fuel pump as defined by claim 12, wherein each central internal region includes a flattened face, which is disposed perpendicular to a longitudinal axis of the roller.

17. The high-pressure fuel pump as defined by claim 13, wherein each central internal region includes a flattened face, which is disposed perpendicular to a longitudinal axis of the roller.

18. The high-pressure fuel pump as defined by claim 14, wherein each central internal region includes a flattened face, which is disposed perpendicular to a longitudinal axis of the roller.

19. The high-pressure fuel pump as defined by claim 11, wherein each central internal region includes an indentation.

20. The high-pressure fuel pump as defined by claim 12, wherein each central internal region includes an indentation.

21. The high-pressure fuel pump as defined by claim 13, wherein each central internal region includes an indentation.

22. The high-pressure fuel pump as defined by claim 15, wherein each central internal region includes an indentation.

23. The high-pressure fuel pump as defined by claim 12, wherein the circular-annular disk faces are raised relative to associated coaxial outer regions.

24. The high-pressure fuel pump as defined by claim 12, wherein viewed in longitudinal section through the roller, the coaxial outer regions taper frustoconically.

25. The high-pressure fuel pump as defined by claim 11, wherein a transition between each central internal region and its associated circular-annular disk face is rounded.

26. The high-pressure fuel pump as defined by claim 22, wherein a transition between each central internal region and its associated circular-annular disk face is rounded.

27. The high-pressure fuel pump as defined by claim 11, wherein a transition between each circular-annular disk face and its associated coaxial outer region is rounded.

28. The high-pressure fuel pump as defined by claim 22, wherein a transition between each circular-annular disk face and its associated coaxial outer region is rounded.

29. The high-pressure fuel pump as defined by claim 11, wherein a transitions between each coaxial outer region and a cylindrical body of the roller is rounded.

30. The high-pressure fuel pump as defined by claim 22, wherein a transitions between each coaxial outer region and a cylindrical body of the roller is rounded.
